(19) United States
(12) Patent Application Publication
(10) Pub. No.: US 2007/0295746 A1
(43) Pub. Date: Dec. 27, 2007

(54) Cup dispenser

(76) Inventor: Robert J. Gapp, Winnetka, IL (US)

Correspondence Address: WELSH & KATZ, LTD, 120 S RIVERSIDE PLAZA, 22ND FLOOR, CHICAGO, IL, 60606, US

(21) Appl. No.: 11/555,928

(22) Filed: Nov. 2, 2006

Related U.S. Application Data
(60) Provisional application No. 60/816,898, filed on Jun. 27, 2006.

(51) Int. Cl. G07F 11/16

(52) U.S. Cl. 221/304

(57) ABSTRACT

A spring loaded adjustable cup dispenser featuring a tubular design with an open end and at least one adjustable cup retaining member disposed therein. After being installed in a counter or cabinet having a flat surface, the adjustable retaining members of the dispenser are accessible through the open end. Once accessed, the retaining members may be radially adjusted from a setting enabling the dispenser to house and dispense cups of a particular size to house and dispense cups of a different size. A cup retaining member is further provided. The retaining member features a first and second end connected together by an elongated body. The retaining member additionally features a rounded edge between the second end and the elongated body which is adapted to engage the lip of the uppermost cup in a dispenser in a manner which enables the cups to be readily dispensed one at a time.

### CROSS-REFERENCE TO RELATED APPLICATION

This application claims priority from U.S. Provisional Patent Application Ser. No. 60/816,898 filed Jun. 27, 2006 entitled “Cup Dispenser”.

### FIELD OF THE INVENTION

The present invention relates generally to a cup dispenser, and is particularly directed to a dispenser which can be adjusted, after being installed in a counter or cabinet, from a setting enabling the dispenser to house and dispense cups of a particular size to house and dispense cups of a different size.

### BACKGROUND OF THE INVENTION

Devices which can be installed into countertops or cabinets for housing and dispensing cups have been well known for some time. These devices generally feature an elongated unit for storing a supply of cups inversely stacked in an interfitted configuration and an opening through which individual cups are dispensed. Known devices having these characteristics are often designed for use with cups having a particular size and typically cannot easily be adapted to house and dispense cups having a larger or smaller diameter. Thus, in order to house or dispense a different sized supply of cups, a plurality of various sized dispensers must be used, or a dispenser adapted to house cups of a particular size must be uninstalled and replaced with an alternate sized dispenser.

Accordingly, there is a need in the art for a dispenser which can be adjusted, after being installed in a counter or cabinet, from a setting enabling the dispenser to house and dispense cups of a particular size to house and dispense cups of a different size. The present invention meets this need by incorporating the elements and features described herein.

### SUMMARY OF THE INVENTION

The present invention features a cup dispenser which may be adjusted after being installed in a counter or cabinet, from being able to house and dispense cups of a particular size to house and dispense cups having a different size. In one embodiment, the dispenser features a hollow tubular member having an open end with a flange extending from the tubular member in an outward direction perpendicular to the tubular member. At least one adjustable retaining member is recessed within the hollow tubular member proximate to the open end and adapted to radially extend from the flange toward a centerline of the tubular member. The present invention is also directed to an adjustable retaining member of the type described further herein.

Further objects, features and advantages of the present invention will be apparent from the following description and the appended claims when taken in conjunction with the accompanying drawings.

### BRIEF DESCRIPTION OF THE DRAWINGS

FIG. 1 is an elevational view of the adjustable dispenser of the present invention with a section of the tubular member partially cut-away to show a supply of cups housed therein.

FIG. 2 is a perspective view of the adjustable dispenser of the present invention showing a plurality of cups housed therein.

FIG. 3 is a close-up perspective view of the open end of the adjustable dispenser showing a plurality of cups housed therein.

FIG. 4 is a perspective view of the exposed flange showing the adjustable retaining members fully-extended around a cup housed in the dispenser.

FIG. 5 is a perspective view of the exposed flange showing the adjustable retaining members in an intermediate position.

FIG. 6 is a perspective view of the exposed flange showing the adjustable retaining members in a fully-retracted position.

FIG. 7 is a top plan view of the open end of the adjustable dispenser with the annular cover positioned over the flange and a plurality of adjustable retaining members engaging the top lip of a cup housed in the dispenser.

FIG. 8 is a top plan view of the adjustable dispenser without the cover showing the adjustable retaining members fully-extended around a cup housed in the dispenser.

FIG. 9 is a top plan view of the adjustable dispenser without the cover showing the adjustable retaining members in an intermediate position around a cup housed in the dispenser.

FIG. 10 is a perspective view of the open end of the adjustable dispenser without the cover and with the adjustable retaining members in a fully-retracted position.

FIG. 11 is a perspective view of the open end of the adjustable dispenser without the cover and with the adjustable retaining members in an intermediate position.

FIG. 12 is a perspective view of the open end of the adjustable dispenser without the cover and with the adjustable retaining members in a fully-extended position.

FIG. 13 comprises alternate views of an adjustable retaining member of the present invention.

FIG. 14 is a close-up view of the first and second end of an adjustable retaining member of the present invention.

### DETAILED DESCRIPTION OF THE INVENTION

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description of the Invention”) relates to a requirement of the United States Patent Office, and should not be found to limit the subject matter disclosed herein.

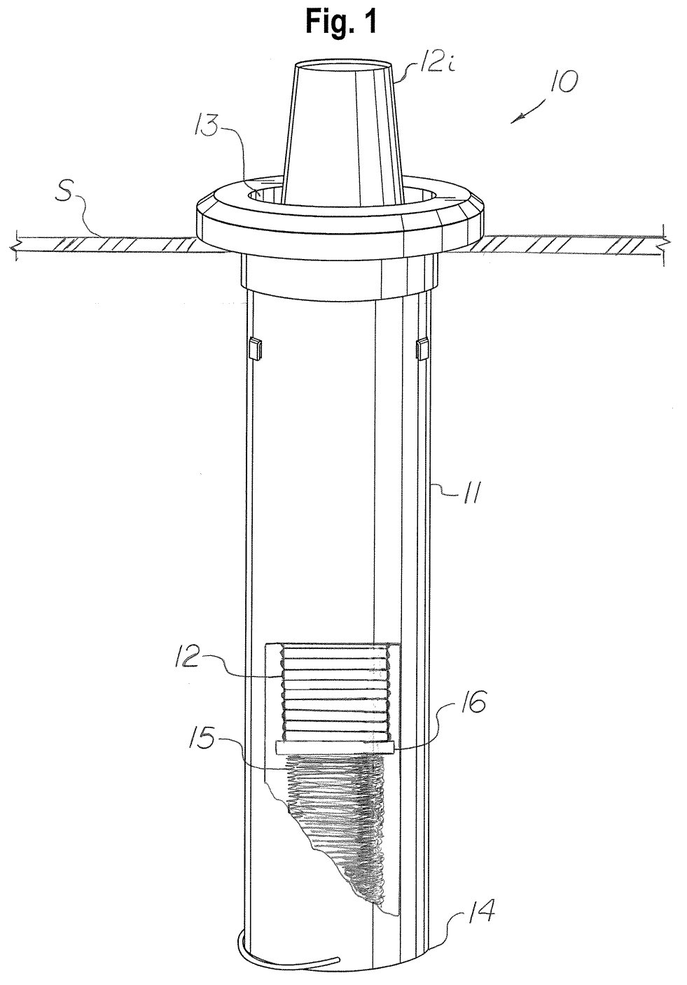

FIG. 1 illustrates an adjustable cup dispenser 10 which embodies the present invention showing a supply of cups housed therein. In this embodiment, an elongated tubular member 11 is provided which houses a supply of cups or other cup-like objects 12 positioned in a stacked interfitted configuration. As shown in FIG. 1, the dispenser 10 is intended to be installed in a cabinet or counter having a flat surface S such that the tubular member 11 is located within the cabinet or counter. The tubular member features an open end 13 and a closed end 14 with a spring 15 axially positioned therein such that it is in contact with the closed end 14 of the tubular member 11. The top end of the spring 15 features a removable disk 16 which is adapted to have a supply of cups placed thereon 12. While the tubular member 11 illustrated in FIG. 1 is shown to have a cylindrical shape, it may be shaped in an alternative configuration and may further be made of a variety of constructions including, but not limited to, metal or plastic without departing from the scope of the present invention.

When a supply of cups 12 are loaded into the dispenser 10 through the open end 13, the spring 15 within the tubular member 11 compresses, and the disk 16 holding the cups moves in a direction towards the closed end of the tube 11. The apparatus is adapted to dispense cups from the open end one at a time. As cups are dispensed from the open end 13 of the apparatus, the spring 15 within the tubular member 11 extends and pushes the remaining supply of cups 12 in the direction of the open end such that the uppermost cup 12i will be positioned in a manner in which it can be readily dispensed from the apparatus.

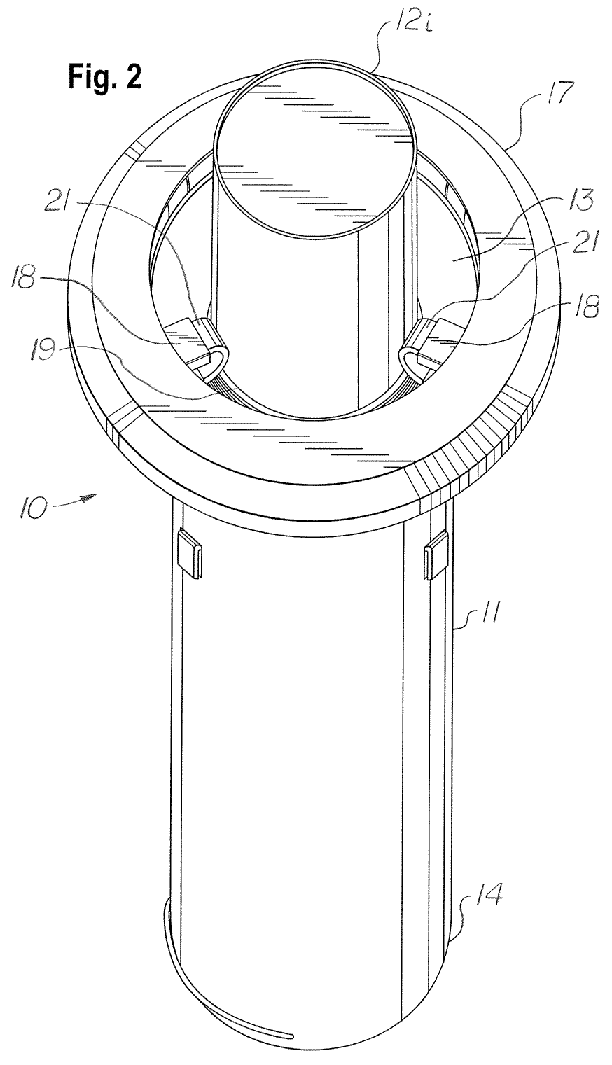

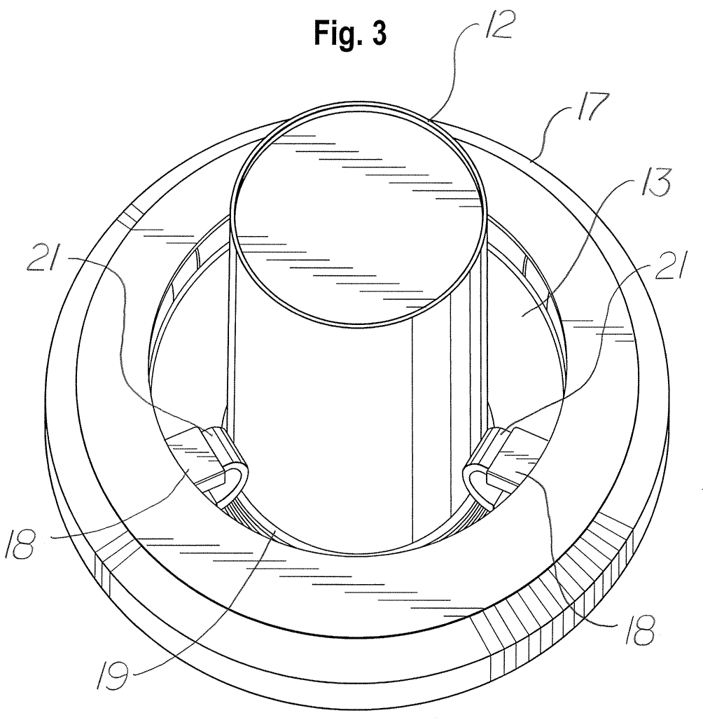

As illustrated in FIGS. 2-3, the dispenser additionally features a removable annular cap 17 affixed around the open end 13 of the tubular member 11 through which cup-like objects 12 are dispensed. While the cap 17 in this embodiment is shown to be ring-shaped, the size and shape of the cap may vary and will be configured to correspond to the size and shape of the dispenser 10 and opening 13. When the dispenser 10 is installed into a cabinet or countertop having a flat outer surface, the cap 17 is positioned outside the surface and can be removed from the dispenser 10 in order to obtain access to the open end 13 of the dispenser 10. The cap 17 serves both to make the preferred embodiment more aesthetically pleasing and to protect the flange and adjustable retaining members 18 positioned beneath the cap 17 and around the opening.

FIGS. 2 and 3 further show a partial view of a plurality of adjustable retaining members 18. The retaining members are located in a recessed position in the tubular member proximate to the open end 13 of the tubular member 11 and feature a rounded edge 21 which is adapted to engage the lip 19 of the uppermost cup 12i in the dispenser. By engaging the lip 19 of the uppermost cup 12i, the retaining members 18 counterbalance the force of the spring 15 positioned in the elongated tube 11 and thus keep the supply of cups 12 contained within the dispenser 10. The retaining members 18 of the present invention further enable the cups 12 housed within the dispenser 10 to be removed one at a time, and as discussed in greater detail below, may be adjusted to accommodate cups of varying sizes.

FIG. 3 is a close-up of the opening 13 from which the cup or cup-like objects are dispensed. As shown, the uppermost cup 12i extends through the open end 13 of the dispenser and is oriented in an inverted position such that the top of the cup is within the dispenser while the bottom is outside the dispenser. In this way, the cups may be handled and pulled from the dispenser one at a time for use. After the uppermost cup 12i is pulled from of the dispenser, the next cup advances to engage the retaining members 18 and can now be readily dispensed. Again, while the opening 13 of the dispenser 10 is shown to be of a particular size and shape, the opening 13 could be larger or smaller depending on the size of the objects being dispensed. The cups shown in FIG. 3 are for illustration purposes only and need not be the type of cup used in the preferred embodiment. Further, the preferred embodiment can handle cups both smaller and larger than the cups pictured without departing from the spirit or scope of the present invention.

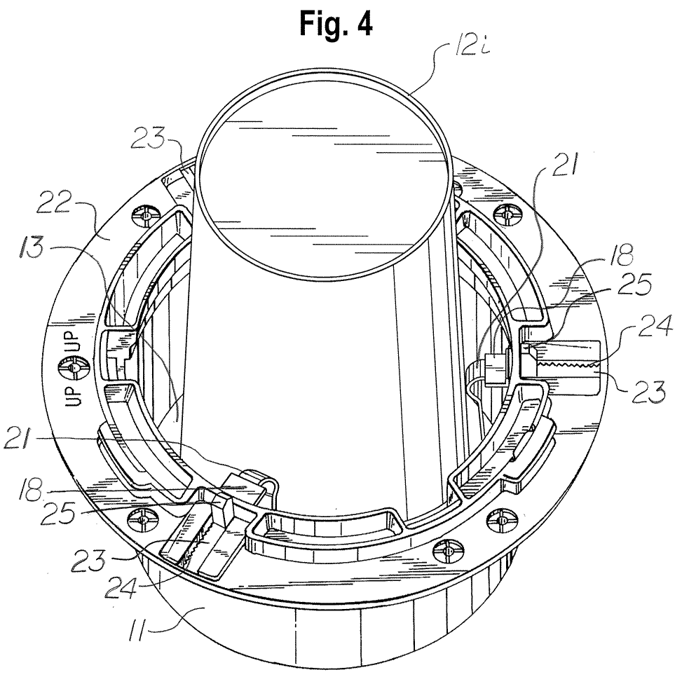

FIGS. 4-6 are close-up views of the open end 13 of the dispenser 10 shown without the removable cap 17. As illustrated in these embodiments, the dispenser of the present invention features a flange 22 which extends from the tubular member 11 in an outward direction perpendicular to said member. The flange 22 serves as the point at which the dispenser is attached to the surface of a cabinet or countertop and further acts as an attachment point for the adjustable retaining members 18 recessed at the open end of the elongated tubular member 11. The flange 22 may be mounted to the surface of a countertop or cabinet in either an under-mounted configuration or in an over-mounted configuration. In the under-mounted configuration, the flange 22 is affixed to the bottom surface of the counter or cabinet and is thus positioned below the horizontal plane of the surface. In the over-mounted configuration, the flange 22 is affixed to the top surface of the countertop or cabinet and is therefore positioned slightly above the horizontal plane of the surface. In either configuration, the flange 22 is sized and shaped so that the retaining members 18 may be accessible from outside the cabinet once the cover 17 is removed, and further so that the surface of the cabinet or countertop will not interfere with the radial movement of the retaining members 18.

The flange 22 of the present invention additionally features at least one elongated slot 23 having a radial orientation around the centerline of the tubular member 11 and a saw-toothed formation 24 adjacent to the slot. The slot 22 is adapted to receive a manually deflectable guide member 25 positioned on the adjustable retaining member 18 which is positioned below the flange 22.

FIGS. 4-6 further illustrate the manner in which the retaining members 18 move in order to accommodate cups of varying sizes which may be dispensed from the open end 13 of the dispenser 10. In one embodiment, the retaining members 18 feature a saw-tooth formation 26 and a manually deflectable guide member 25. The deflectable guide member 25 is adapted to extend through the elongated slot 23 of the flange 22 and the saw-tooth formation 26 of the retaining member 18 is adapted to releasably engage the complementary saw-tooth formation 24 adjacent the elongated slot 23 on the flange 22. By engaging the flange 22 in this manner, an adjustable retaining member 18 is adapted to slideably and lockingly engage the flange 22 in a plurality of displaced locations.

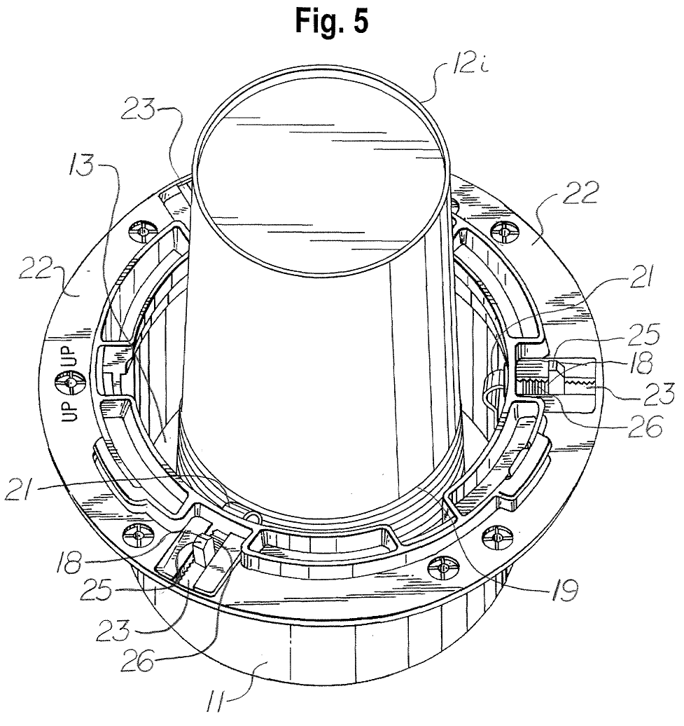

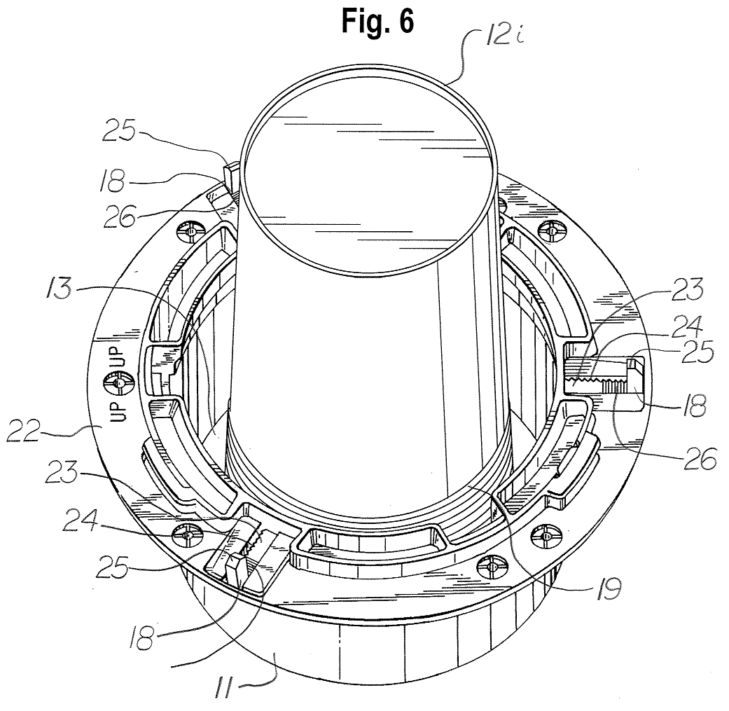

FIG. 4 illustrates one embodiment of the present invention where the adjustable retaining members 18 are each shown in a fully-extended position to accommodate smaller sized cups. In this position, the rounded edges 21 of the adjustable retaining members 18 are closest to the centerline of the tubular member 11; FIG. 5 shows the adjustable retaining members 18 in an intermediate position between the fully-extended and fully-retracted position; and FIG. 6 shows the adjustable retaining members 18 in a fully-retracted position to accommodate cups having a larger size. In this position, the rounded edges 21 of the adjustable retaining members 18 are the farthest from the centerline of the tubular member 11.

FIG. 7 is a top plan view of the open end of the adjustable dispenser 10 with the annular cover 17 positioned over the flange 22 and the adjustable retaining members 18 engaging the top lip 19 of a cup 12i housed in the dispenser 10. As illustrated, the rounded edges 21 of the retaining members 18 are positioned above the lip 19 of the cup 12i and thus keep it from extending out of the dispenser 10. In this embodiment, the elongated slots 23 of the flange 22 are enclosed by the cover 17 and are thus protected from foreign matter which could possibly accumulate on or within the slots 23 and thus interfere with the movement of the retaining members 18.

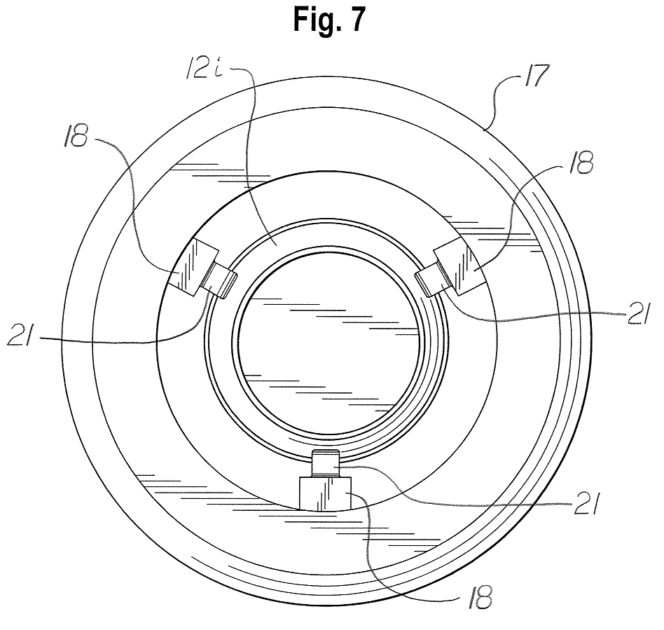

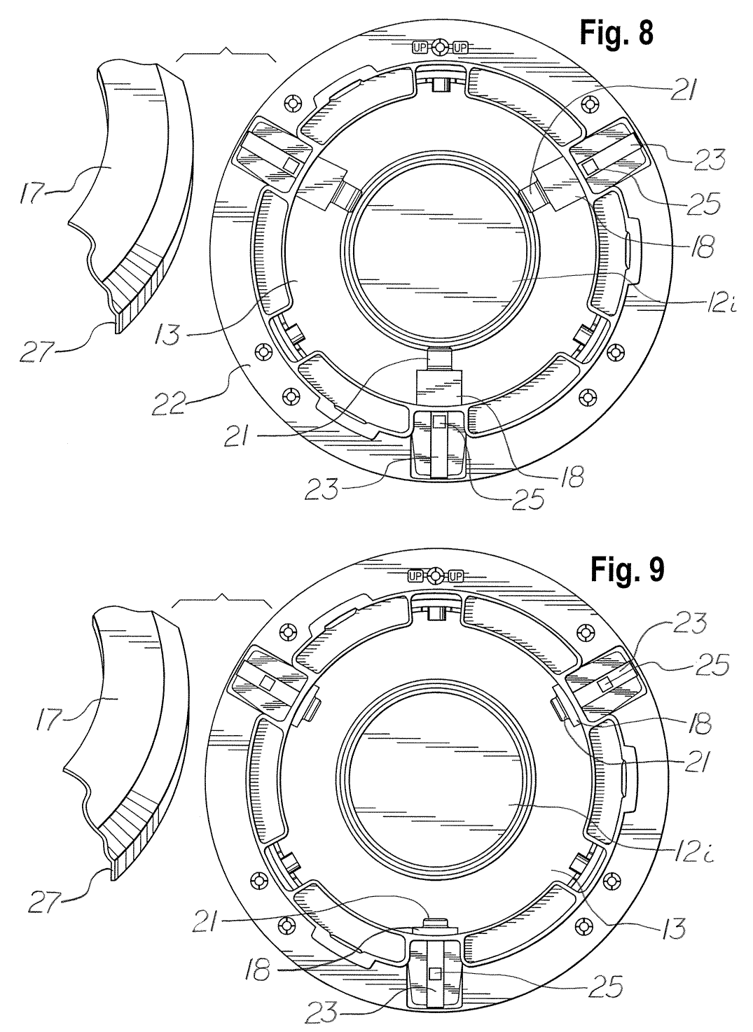

FIGS. 8 and 9 show a top plan view of the adjustable dispenser 10 without the annular cover 17 positioned over the flange 22. As shown, the flange 22 is exposed such that the retainer members 18 may be manually adjusted. In this embodiment at least one cup 12i is housed in the dispenser 10; for illustrative purposes, the cup shown in both FIGS. 8 and 9 is substantially the same size. In FIG. 8, a plurality of adjustable retainers 18 are shown to be fully-extended around the top lip 19 of the uppermost cup 12i in the dispenser. In this arrangement, the manually deflectable guide member 25 is advanced to the innermost position within the slot of the flange 22. FIG. 9 shows a plurality of adjustable retainers 18 to be in an intermediate position and no longer engaging the uppermost cup 12 in the dispenser 10. To move a retainer member from the position illustrated in FIG. 8 to the position shown in FIG. 9, the manually deflectable guide member 25 is actuated. Once actuated, the saw-tooth formation 26 of the retainer member 18 disengages from the complementary saw tooth formation 24 adjacent to the slot 23. After disengaging from the flange 22, the retainer member 18 may be adjusted by manipulating the deflectable guide member 25 within the elongated slot 23 of the flange 22. By manipulating the deflectable guide member 25, the adjustable retainer member 18 may be moved in either an inwardly or outwardly direction to accommodate a supply of cups of a particular size. Once the correct position of the retaining member 18 is achieved, the deflectable guide member 25 is released and the saw-tooth formation 26 of the retainer member 18 engages an alternate location of the complementary saw tooth formation 24 of the flange 22. Accordingly, an adjustable retaining member 18 of the present invention is adapted to slideably and lockingly engage the flange in a plurality of displaced locations.

FIGS. 8 and 9 additionally show a partial elevation view of the flange 22 of one embodiment of the present invention. In this embodiment, the flange 22 has an elevated configuration with a rim 27 extending in a downward direction around the edge. This configuration provides additional space beneath the flange 22 so that when the dispenser 10 is fastened to a countertop or cabinet surface in the over-mounted configuration, the countertop or cabinet surface will not interfere with the movement of the second end 29 of the adjustable retaining members 18 which are positioned beneath the flange.

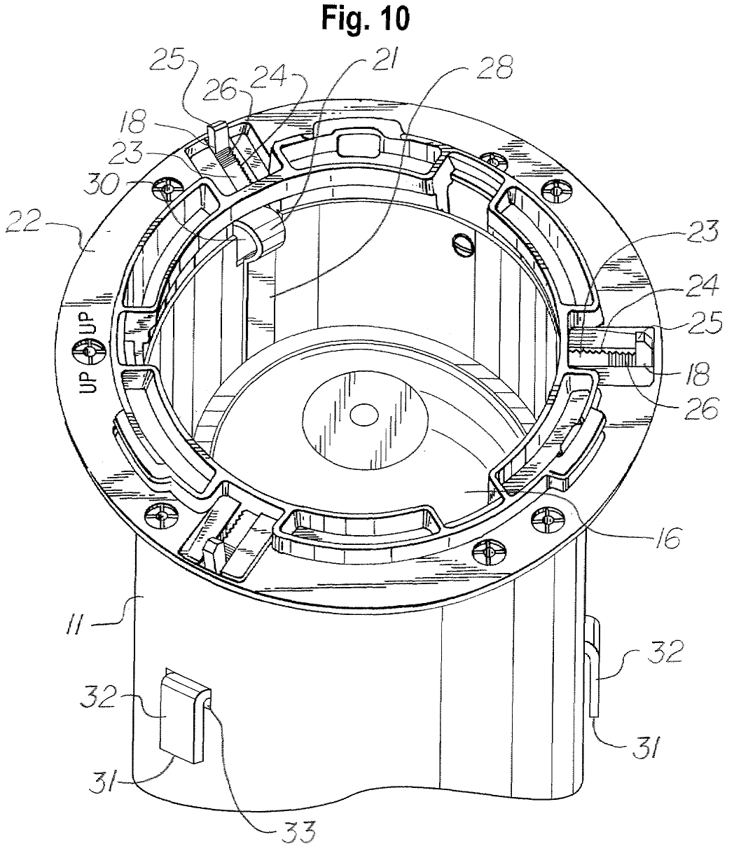

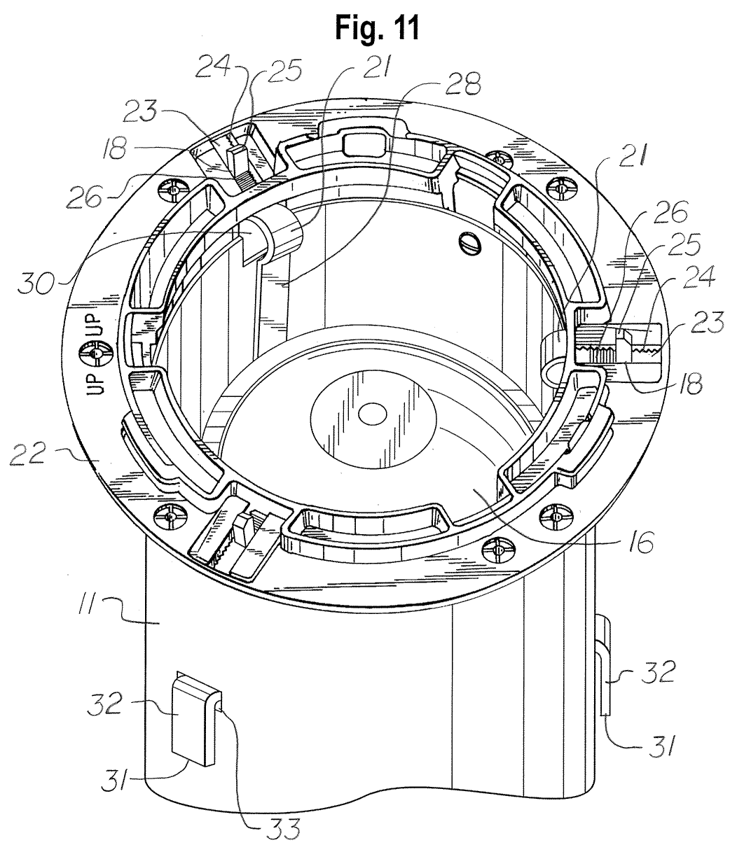

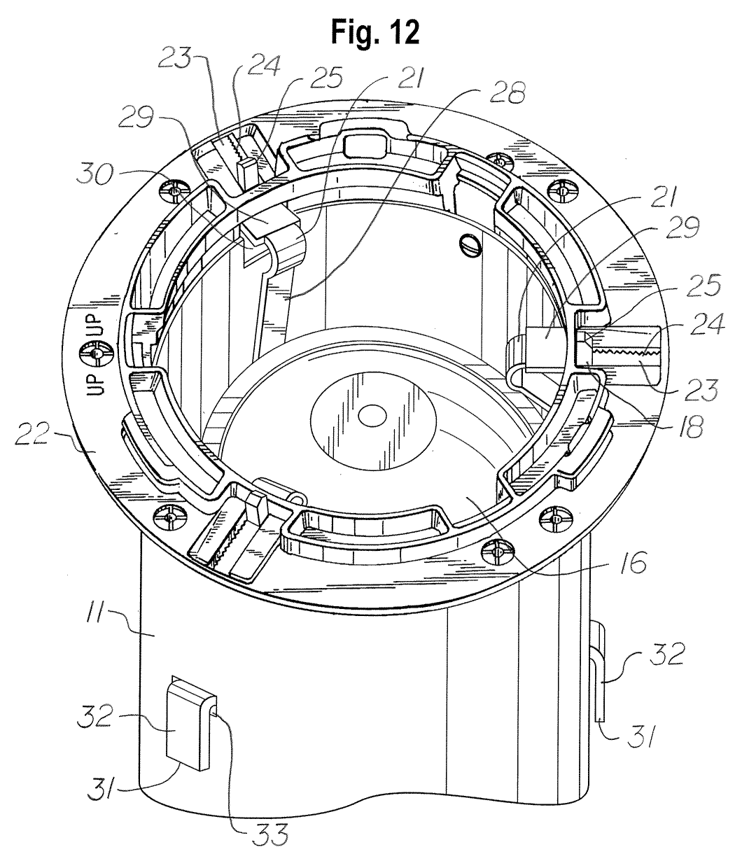

FIGS. 10, 11 and 12 show an alternative view of the dispenser 10 of one embodiment the present invention without a supply of cups housed therein and further having a plurality of adjustable retaining members 18 in different positions. FIG. 10 shows the retaining members 18 in a fully-retracted position such that the deflectable guide member 25 is positioned adjacent to the outside edge of the slot 23 of the flange 22. FIG. 11 illustrates the retaining members 18 in an intermediate position such that the deflectable guide member 25 of each retaining member 18 is between the inside and outside edge of the slot 23. Alternatively, the retaining members 18 shown in FIG. 12 are in the fully-extended position such that each of the deflectable guide members 25 are positioned adjacent to the inside edge of the slot 23 of the flange 22.

FIGS. 10-12 also illustrate the placement of the adjustable retaining members 18 when positioned within the dispenser 10. As shown in the drawings, the retaining members feature an elongated portion 28 which is oriented substantially parallel to the tubular member 11 at a location proximate to the open end 13 of the dispenser 10. The rounded edge 21 of the retaining member 18 is also shown which connects the elongated portion 28 to the second end 29 of the retaining member. The second end 29 of the retaining member 18 extends in an outward direction through a first lateral opening 30 in the tubular member 11 proximate to the open end 13 of the dispenser 10. The deflectable guide member 25 extends from the second end 29 of the retaining member through the elongated slot 23 of the flange 22. FIGS. 10-12 also show the first end 31 of the retaining member 18 engaging the tubular member 11 at a point away from the open end 13 of the dispenser 10. The first end 31 features an arm 32 which extends from the retaining member 18 in a direction away from the second end 29 to generally form a ‘U’-shaped configuration. As shown, the arm 32 at the first end 31 of the retaining member 18 is adapted to extend through a second lateral opening 33 in the tubular member 11 to serve as a lower attachment point for the adjustable retaining member 18.

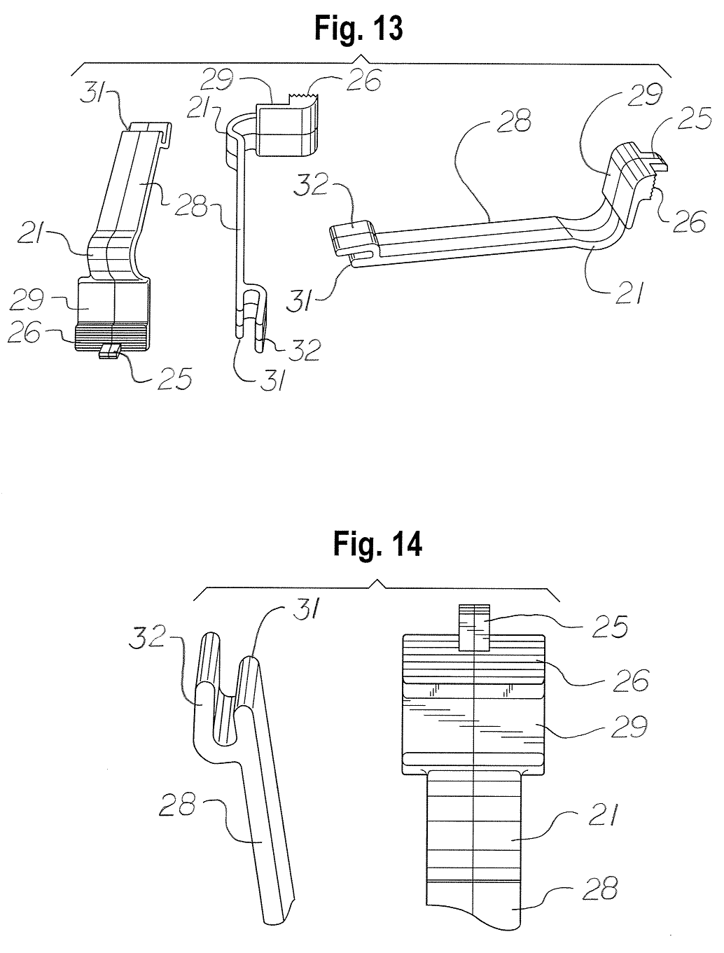

FIGS. 13 and 14 show an adjustable retaining member 18 of one embodiment of the present invention in isolation. As shown, the retaining member 18 has a first 31 and second 29 end connected together by an elongated portion 28. The retaining member 18 has a rounded edge 21 between the second end 29 and the elongated portion 28 which extends over the elongated portion 28 before bending back towards the second end 29. The second end 29 of the retaining member 18 extends in a direction roughly perpendicular to the elongated portion 28 and generally has an ‘L’-shaped configuration. The second end 29 may additionally feature a saw-tooth formation 26 on the second end and/or a manually deflectable guide member 25 which extends from the second end 29 in an axial direction. The first end 31 of the retaining member 18 features an arm 32 which extends from the retaining member 18 in a direction away from the second end 29 to generally form a ‘U’-shaped configuration.

The present disclosure includes that which is contained in the appended claims, as well as that of the forgoing description. Although, this invention has been described in its preferred form with a certain degree of particularity, it is understood that the present disclosure of the preferred form has been made only by way of example, and that numerous changes in the details of the elements, compositions and the combination of individual ingredients may be resorted to without departing from the spirit or scope of the invention.

What is claimed is:

1. A cup dispenser comprising:
a hollow tubular member having an open end with a flange extending from the tubular member in an outward direction perpendicular to said member;
at least one adjustable cup retaining member recessed within the hollow tubular member proximate to the open end of said member and adapted to radially extend from the flange toward a centerline of said tubular member.

2. The cup dispenser of claim 1 having a plurality of adjustable retaining members.

3. The cup dispenser of claim 1 wherein the retaining member has first and second ends, said first end engages the tubular member, said second end engages the flange.

4. The cup dispenser of claim 3 wherein the second end of the retaining member slideably and lockingly engages the flange.

5. The cup dispenser of claim 3 wherein the second end of the retaining member releaseably engages the flange at a plurality of displaced locations.

6. The cup dispenser of claim 5 further comprising an annular cap member which overlays and releaseably engages the flange.

7. The cup dispenser of claim 6 wherein the tubular member, the flange and the annular member extend axially relative to one another along a common centerline.

8. The cup dispenser of claim 7 wherein the flange includes a plurality of radially oriented slots, each slot adapted to receive a portion of the second end of a retaining member.

9. The cup dispenser of claim 8 further comprising a plurality of radially adjustable retaining members.

10. The cup dispenser of claim 9 wherein the radially adjustable retaining members have a first and second end connected together by an elongated body, said first end having a generally U-shaped configuration, the second end of said retaining member having a generally L-shaped configuration.

11. The cup dispenser of claim 10 wherein the radially adjustable retaining members have a rounded edge between the second end and the elongated body, the rounded edge extending over the elongated body before bending back towards the second end of the retaining member.

12. The retaining member of claim 11 wherein the second end of the retaining member has a manually deflectable guide member extending axially therefrom, the guide member adapted to extend through the radially oriented slots of the flange.

13. The retaining member of claim 12 wherein the second end of the retaining member has a saw-tooth formation adapted to engage the flange.

14. A retaining member comprising:
a first and second end connected together by an elongated body, said first end having a generally U-shaped configuration, the second end of said retaining member having a generally L-shaped configuration.

15. The retaining member of claim 14 further comprising a rounded edge between the second end and the elongated body, the rounded edge extending over the elongated body before bending back towards the second end of the retaining member.

16. The retaining member of claim 14 wherein the first end has an arm extending therefrom, the arm angled in a direction away from the second end of the retaining member.

17. The retaining member of claim 14 wherein the second end of the retaining member has a saw-tooth configuration.

18. The retaining member of claim 14 wherein the second end of the retaining member has a manually deflectable guide member extending axially therefrom.

19. The retaining member of claim 18 wherein the manually deflectable guide member of the second end extends from the same surface as the saw-tooth configuration.

20. A cup dispenser comprising:
a hollow tubular member having an open end with a flange extending from the tubular member in an outward direction perpendicular to said member, the flange having at least one slot radially oriented around a centerline of the tubular member and a saw-toothed formation adjacent to the slot;
a spring axially positioned within the tubular member;
a disk removably affixed to the spring housed within the tubular member, said disk adapted to have a supply of cups placed thereon;
an annular cap removably affixed to the flange around the open end of the tubular member; and
at least one adjustable cup retaining member recessed within the hollow tubular member proximate to the open end of said member and adapted to radially extend from the flange toward the centerline of said tubular member, said retaining member having a first and second end connected together by an elongated body, said first end having a generally U-shaped configuration, the second end of said retaining member having a generally L-shaped configuration, the retaining member further having a manually deflectable guide member and saw-tooth formation at the second end, the guide member adapted to extend through the slot of the flange, the saw-tooth formation of the retaining member adapted to engage the saw-tooth formation of the flange, the retaining member further having a rounded edge between the second end and the elongated body, the rounded edge extending over the elongated body before bending back towards the second end of the retaining member.
